(19) United States
(12) Patent Application Publication
(10) Pub. No.: US 2019/0215627 A1
(43) Pub. Date: Jul. 11, 2019

(54) HEARING ASSISTANCE DEVICE

(71) Applicant: ORELLO HEARING TECHNOLOGIES INC., Vancouver (CA)

(72) Inventors: William BRENNER, Surrey (CA); Julius MICHAEL, Vancouver (CA); Eunice KUATSJAH, Burnaby (CA); Abdurakhman SMAZOV, Burnaby (CA)

(21) Appl. No.: 15/868,800

(22) Filed: Jan. 11, 2018

(51) Int. Cl. H04R 25/00

(52) U.S. Cl. CPC H04R 25/652; H04R 2225/023; H04R 2225/025; H04R 2225/021

(57) ABSTRACT

A method of fitting a hearing assistance device includes heating and earmold including plastic material to a temperature sufficient to facilitate molding of the plastic material, the earmold being insertable into an ear of a user for molding in an ear of a user, and allowing the earmold to cool to provide a shaped earmold.

### TECHNICAL FIELD

The present disclosure relates to hearing assistance devices, such as hearing aids, personal audio amplifiers, and earphones.

### BACKGROUND

Hearing assistance devices such as hearing aids and personal audio amplifiers are commonly utilized to improve hearing for people, particularly those with hearing loss. Such devices are complex devices that receive sound signals and manipulate the sound signals for the purpose of providing sound to the ear without providing additional noise from, for example, wind or other background noises. The physical configuration of the device affects the operation and effectiveness of such devices.

Because hearing assistance devices are important for people with impaired hearing to interact with others, these devices may be worn for long periods of time. For example, a hearing impaired person may wear a hearing aid for many hours at a time, inserting an earpiece into the ear soon after waking and removing the earpiece before going to sleep. As a result, the physical configuration of such devices is also important for comfort of the user.

To ensure a correct fit, hearing aids are fitted by an audiologist to provide a suitable configuration for comfort and effective manipulation of the sound for use.

Improvements in hearing assistance devices are desirable.

### SUMMARY

According to an aspect of the present invention, there is provided a method of fitting a hearing assistance device including an earmold that includes plastic material. The method includes heating the earmold to a temperature sufficient to facilitate molding of the plastic material. The earmold is insertable into an ear of a user for molding in an ear of a user. The method also includes allowing the earmold to cool to provide a shaped earmold.

### DRAWINGS

Embodiments of the present invention will be described, by way of example, with reference to the drawings and to the following description, in which:

FIG. 1 is a block diagram of a hearing assistance device in accordance with an embodiment of the present invention;

FIG. 2 is a perspective view of an example of a hearing assistance device in accordance with an embodiment of the present invention;

FIG. 3 is a perspective view of another example of a hearing assistance device in accordance with an embodiment of the present invention;

FIG. 4 is a perspective view of an example of a heater for use with the hearing assistance device, in accordance with an embodiment of the present invention; and

FIG. 5 is a flowchart showing a method of fitting a hearing assistance device in accordance with an embodiment of the present invention.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The disclosure generally relates to a hearing assistance device, a kit, and a method of fitting a hearing assistance device including an earmold that includes plastic material. The method includes heating the earmold to a temperature sufficient to facilitate molding of the plastic material. The earmold is insertable into an ear of a user for molding in an ear of a user. The method also includes allowing the earmold to cool to provide a shaped earmold.

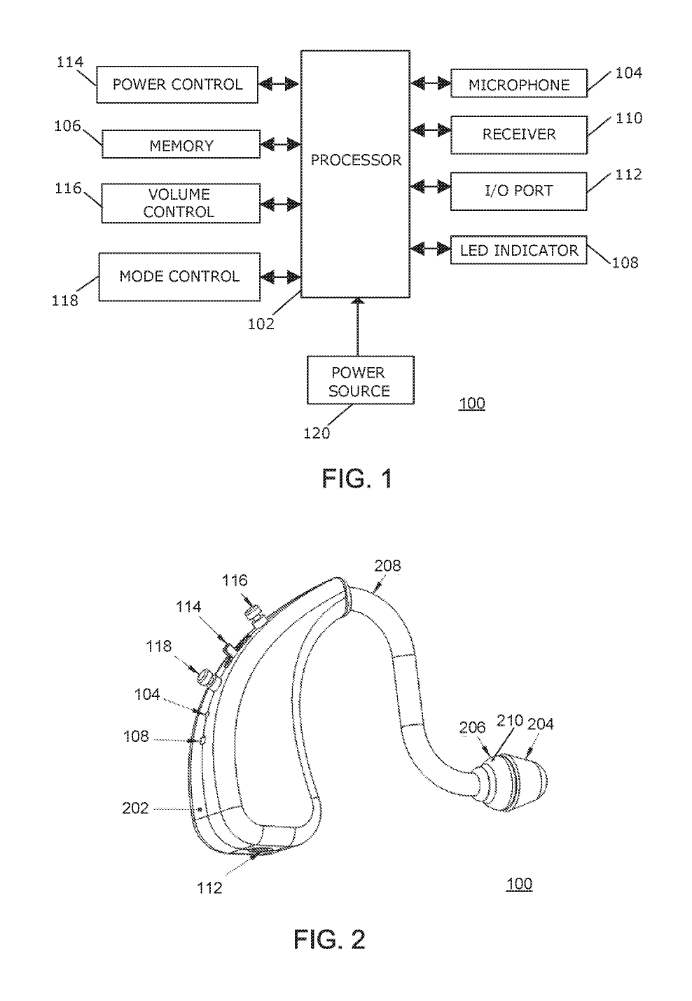

A simplified block diagram of an example of a hearing assistance device 100 is shown in FIG. 1. The hearing assistance device 100 includes the processor 102 that interacts with other components of the hearing assistance device 100, including, for example, a microphone 104, a memory 106, an LED indicator 108, receiver 110, an input/output (I/O) port 112, a power control switch 114, a volume control 116, and a mode control 118. The processor 102 also interacts with a power source 120 that provides power to the components of the hearing assistance device 100.

Input to the hearing assistance device 100 may be provided via the microphone that receives sound signals that are manipulated by the processor 102. Input is also provided via the power control switch 114 for powering the hearing assistance device 100 on and off, the volume control 116 for controlling the volume of the output from hearing assistance device 100, and the mode control 118 for controlling the hearing assistance device mode.

Input is also provided via the I/O port 108 that may be utilized for coupling to the processor 102 for programming the hearing assistance device 100 to configure the hearing assistance device 100 to manipulate sounds for the user, depending on the particular user. For example, the processor may be programmed to highlight a specific spatial region or range or frequency or range of frequencies.

The memory 106, may be, for example, flash memory, utilized for persistent storage.

Output from the hearing assistance device 100 may be provided by the LED indicator 108 for indicating operation, power, or a mode of the hearing assistance device 100. Output is also provided by the receiver 110 for receiving manipulated sound signals from the processor 102 and producing manipulated sound from the manipulated sound signals received from the processor 102.

The power source 120 may be any suitable power source, such as a rechargeable battery.

A perspective view of an example of a hearing assistance device is shown in FIG. 2. The hearing assistance device is indicated generally by the numeral 100. In the present example, the hearing assistance device 100 is a behind-the-ear hearing aid and includes a body 202 for locating outside and generally behind the ear of the user. The body 202 houses several of the components of the hearing assistance device 100, described above. The body houses the processor 102 and the memory 106 (shown in FIG. 1). In addition, the body 202 includes a microphone port for housing the microphone 104 for receiving sound signals. The microphone 104 is coupled to the processor 102 for receiving the sound signals from the microphone 104 and manipulating the received sound signals.

The body 202 also includes several other ports for input/output to the processor for interfacing with the hearing assistance device 100. For example, the body 202 includes a port through which the power control switch 114 extends for turning on and off power from the power source housed in the body 202. The power source may be any suitable battery for providing power to the components of the hearing assistance device 100. The body 202 also includes the volume control 116 and a mode control 118 extending therefrom for controlling the volume and mode of the hearing assistance device 100.

The LED indicator 108 may be included to indicate the operation of the hearing assistance device 100 and the I/O port 112 may be utilized for coupling another device to the processor for programming the hearing assistance device 100 for configuring the hearing aid to manipulate sounds for the user.

The body 202 is coupled to an earmold 204 and receiver housing 206 by audio tubing 208. The receiver 110 is housed in the receiver housing 206 coupled to the back of the earmold 204 for producing manipulated sound from manipulated sound signals received from the processor. An airflow channel 210 may be included in the receiver housing 206.

The earmold 204 is utilized for disposing in the ear of the user and directing the manipulated sound into the ear of the user. The earmold 204 includes a plastic material, such as a thermoplastic material. The thermoplastic material may be heated to a temperature that is above the glass-transition temperature of the thermoplastic to facilitate malleability and molding of the thermoplastic material to fit the ear canal of the user. Upon cooling of the thermoplastic material, the thermoplastic falls below the glass-transition temperature and becomes harder or less malleable.

A suitable thermoplastic material may be, for example, Polycaprolactone (PCL), that has a melting temperature in the range of 55-60° C. and glass transition temperature of about 54° C. The polycaprolactone may be, for example, InstaMorph®, a non-toxic product for handling. Other thermoplastic materials with higher melting point may also be utilized. Heating time, temperature, and cooling for curing may be adjusted to compensate the difference in the thermal properties of the material. Examples of other thermoplastic materials include AorTech Biomaterials Elast-Eon™ E2A Biomedical Polyurethane or RTP 2700 S-30A MD-ISO 10993 Biocompatibility-styrenic-based thermoplastic elastomer (TPE) compounds.

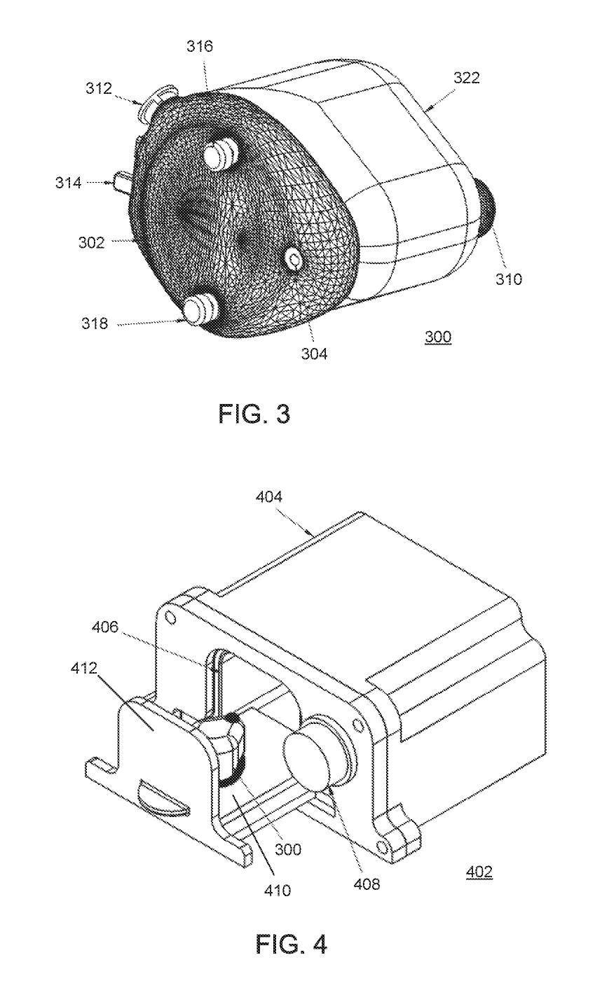

The hearing assistance device is not limited to a behind-the-ear device. Alternatively, the hearing assistance device may be, for example, an in-the-ear hearing aid, an in-canal hearing aid, or a completely in-the-canal hearing aid. A perspective view of another example of a hearing assistance device is shown in FIG. 3. The hearing assistance device in this embodiment is indicated generally by the numeral 300. In the present example, the hearing assistance device 300 is an in-the-ear hearing aid and includes a body 302 for locating in the ear of the user. The body 302 houses several of the components of the hearing assistance device described above with reference to FIG. 1 and FIG. 2. The body 302 houses the processor and the memory. In addition, the body 302 includes a microphone port 304 for housing the microphone for receiving the sound signals.

The body 302 also includes several other ports for input/output to the processor for interfacing with the hearing assistance device 300. For example, the body 302 includes a port through which the power control switch 314 extends for turning on and off power from the power source housed in the body 302. The power source may be any suitable battery for providing power to the components of the hearing assistance device 300. The body 302 also includes the volume control 316 and a mode control 318 extending therefrom for controlling the volume and mode of the hearing assistance device 300.

An I/O port 312 may be utilized for coupling to the processor to, for example, a computer, for programming the hearing assistance device 300 for configuring the hearing aid to manipulate sounds for the user.

In this example, the body 302 includes an earmold 322 at a front or down-canal portion. The entire body 302 in this example is utilized for locating in the ear of the user and the earmold 322 portion includes a plastic material, such as a thermoplastic material. The thermoplastic material may be heated to a temperature that is above the glass-transition temperature of the thermoplastic to facilitate malleability and molding of the thermoplastic material to fit the ear canal of the user. Upon cooling of the thermoplastic material, the plastic becomes harder or less malleable. The receiver 310 is housed in a portion of the earmold 322 for directing the manipulated sound into the ear of the user. The earmold 322 is utilized for fitting into the ear and directing the manipulated sound into the ear of the user.

In both the examples of FIG. 2 and FIG. 3, the earmold is made of plastic material that may be heated to make the plastic more malleable for insertion into the ear of the user and thereby custom-fit the earmold to the ear of the user. The hearing assistance device may be included in a kit, for example, including a heater for heating the earmold to make the plastic malleable for molding to the ear of the user.

FIG. 4 is a perspective view of an example of a heater 402 for a kit including the hearing assistance device, in accordance with an embodiment of the present invention. The heater 402 may be any suitable heater. In the present example, the heater 402 includes an enclosure 404 that encloses one or more heating elements 406. A power control 408 or other suitable interface is provided for turning on and off the heating cycle for heating the hearing assistance device 100. In the present example, the hearing assistance device illustrated with the heater 402 is an in-ear hearing assistance device such as the hearing assistance device 300 shown in FIG. 3. The heater 402 in this example includes a tray 410 coupled to a door 412. The door 412 is movable relative to the enclosure 404 to move between an open position, as shown in FIG. 4, and a closed position. Although not shown, the heater 402 includes an electrical connector for connecting to a power source.

The heater 402 may be any suitable heater. For example, the heater may include an alumina metal ceramic heating element that is utilized for about 5-10 minutes without direct contact to the heating element to heat the earpiece of the hearing assistance device. The ceramic heater may heat up to about 260° C. A fan may be used to increase air circulation to fasten the heating process. The heating process may incorporate timer and temperature limits for safety to inhibit overheating. Alternatively, other heating elements such as infrared ceramic, silicon nitride ceramic, PCT ceramic, polymer PTC, nichrome wire, or resistance wire heating elements may be utilized.

The hearing assistance device or portion of the device may be placed in the heater 402 by placing on the tray 410 when the door 412 of the heater 402 is in the open position. The door 412 is then movable relative to the enclosure 404, to a closed position in which the hearing assistance device is enclosed within the heater 402.

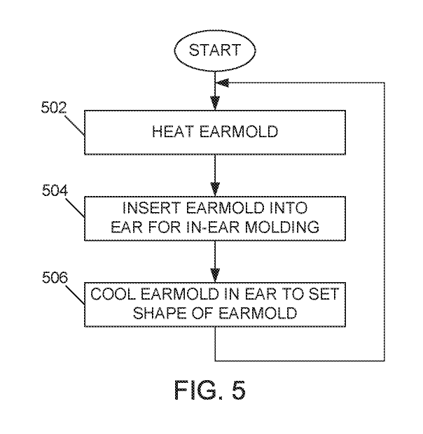

A flowchart illustrating a method of fitting a hearing assistance device, such as the hearing assistance device 100 or the hearing assistance device 300, described above, is shown in FIG. 5. The method may contain additional or fewer processes than shown and/or described, and may be performed in a different order.

The earpiece of the hearing aid in the example shown in FIG. 2 or the entire hearing aid in the example shown in FIG. 3, is heated to a temperature sufficient to facilitate molding of the plastic material at 502. The earpiece is heated by placing the earpiece into the heater and turning on the heater. For example, the earpiece may be placed on the tray 410 and the door 412 of the heater closed.

The heater may be preconfigured or programmed to heat the earpiece for a sufficient period of time such that the earpiece may be inserted into the heater, and power button turned on to initiate the heating cycle and heat the earpiece.

When the heating cycle is complete, the hearing assistance device or portion thereof, is removed from the heater and placed into the ear of the user at 504 for molding to the ear canal of the user. The hearing assistance device is cooled by waiting for a period of time such that the earpiece cools to a temperature below which the plastic material is no longer malleable at 506. For example, for a thermoplastic material, the earpiece is placed into the ear of the user and allowed to cool for about 10 to about 15 minutes to a temperature below a glass transition temperature of the thermoplastic material.

Advantageously, a hearing assistance device, such as a hearing aid or personal audio amplifier, may be quickly and easily custom fitted by the user of the hearing assistance device. Such a custom fitting is particularly useful, for example, in countries in which an audiologist is not available or cannot be utilized because of the associated expense.

The above-described embodiments of the invention are intended to be examples only. Alterations, modifications, and variations may be effected to the particular embodiments by those skilled in the art. Thus, the scope of the claims should not be limited by the embodiments set forth in the examples, but should be given the broadest interpretation consistent with the description as a whole.

1. A method of fitting a hearing assistance device comprising an earmold comprising a plastic material, the method comprising:
heating the earmold to a temperature to a temperature sufficient to facilitate molding of the plastic material, the earmold being insertable into an ear of a user for molding in an ear of a user;
allowing the earmold to cool to provide a shaped earmold.

2. The method according to claim 1, wherein the plastic comprises a thermoplastic material and heating comprises heating to a temperature above a glass-transition temperature of the thermoplastic material.

3. The method according to claim 2, wherein allowing the earmold to cool comprises allowing the earmold to cool below the glass transition temperature to set a shape of the earmold.

4. A device for hearing assistance, comprising:
a microphone for receiving sound signals;
a processor coupled to the microphone for manipulating the received sound signals;
a receiver coupled to the amplifier for producing a manipulated sound from the manipulated sound signals;
an earmold for directing the manipulated sound from the receiver into the ear, the earmold comprising a thermoplastic material for heating, inserting into an ear to shape the earmold, and cooling below a glass transition temperature of the thermoplastic material to set the shape.

5. The device according to claim 4, wherein the device comprises a behind-the-ear hearing aid.

6. The device according to claim 4, wherein the device comprises an in-the-ear hearing aid.

7. The device according to claim 4, wherein the device comprises a receiver-in-canal hearing aid.

8. The device according to claim 4, wherein the device comprises a completely-in-the-canal hearing aid.

9. A kit comprising:
a heating device;
a device for hearing assistance comprising:
a microphone for receiving sound signals;
a processor coupled to the microphone for manipulating the received sound signals;
a receiver coupled to the amplifier for producing a manipulated sound from the manipulated sound signals;
an earmold for directing the manipulated sound from the receiver into the ear, the earmold comprising a plastic material for heating in the heating device and inserting into an ear to shape the earmold after heating.

10. The kit according to claim 9, wherein the device for hearing assistance comprises a behind-the-ear hearing aid.

11. The kit according to claim 9, wherein the device for hearing assistance comprises an in-the-ear hearing aid.

12. The kit according to claim 9, wherein the device for hearing assistance comprises a receiver-in-canal hearing aid.

13. The kit according to claim 9, wherein the device for hearing assistance comprises a completely-in-the-canal hearing aid.

14. A method of fitting a hearing assistance device comprising an earmold comprising a thermoplastic material, the method comprising:
heating the earmold to a temperature above a glass transition temperature and below a melting temperature of the thermoplastic material to facilitate molding of the thermoplastic material, the earmold being insertable into an ear of a user for molding in an ear of the user;
allowing the earmold to cool below the glass transition temperature to set a shape of the thermoplastic material.
